(19) United States
(12) Patent Application Publication
(10) Pub. No.: US 2011/0190956 A1
(43) Pub. Date: Aug. 4, 2011

(54) Prognostic-Enabled Power System

(76) Inventors: Neil Kunst, Tucson, AZ (US); Douglas Goodman, Tucson, AZ (US)

(21) Appl. No.: 12/696,344

(22) Filed: Jan. 29, 2010

(51) Int. Cl. G06F 1/28; G06N 5/02

(52) U.S. Cl. 700/292; 706/52

(57) ABSTRACT

A prognostics-enabled power system includes a power source and a removably connected load. A sensor is connected to the power source and situated to identify at least one characteristic produced in response to the removably connected load on the power source. A programmable system is in communication with the sensor, the programmable system situated to calculate a value from the at least one characteristic, wherein the calculated value is indicative of a health status of the power source.

### CROSS-REFERENCE TO RELATED APPLICATION

This application claims priority to co-pending U.S. Provisional Application entitled, “Programmable IEEE P1451 Power System RUL Sensor,” having Ser. No. 60/206,220 filed Jan. 29, 2009, which is entirely incorporated herein by reference.

### STATEMENT REGARDING FEDERALLY SPONSORED RESEARCH OR DEVELOPMENT

This disclosure was made in part with Government support under contract number NNX09CF49-P awarded by the NASA/Stennis Space Center (SSC). The Government may have certain rights in the disclosure.

### FIELD OF THE DISCLOSURE

The present disclosure is generally related to smart power sensors and, more particularly, is related to a novel programmable power system sensor and method of using thereof.

### BACKGROUND OF THE DISCLOSURE

Basic electronic devices, both passive and active, such as capacitors and feedback amplifiers, are subject to accumulative fatigue damage that eventually results in operational failure of the device. The fatigue damage is caused by stresses and strains induced by many mechanisms such as an over-voltage, over-current or over-temperature condition in the normal operating environment of the device. The physics-of-failure of these devices are varied and include crystal-lattice damage, oxide breakdown, junction damage, holes or opens and shorts. Regardless of the exact mechanism of failure, as a device degrades from a state of no damage to a state of damage high enough to deem the device as failed, the degradation of the device often manifests in one or more characteristics: such as an increase in the amplitude of ripple voltage, a change in output voltage or current, or an increase in noise. A fault signature is a collection of one or more such characteristics. As a device degrades, the fault signature often exhibits changes, such as an increase or decrease in the rate of change in amplitude of a particular characteristic measure and, such as voltage. The progression of the changes in signature corresponding from a state of no or little damage to a state of damage resulting in failure of a device is referred to as a “fault-to-failure progression.”

In addition to managing the maintenance of electronic sub-assemblies, assemblies and systems for the early detection of a signature that indicates degradation, power systems that supply power to these assemblies and systems may also be subject to degradation. To prevent power system failures, reasoners process model parameters, such as rules and measurands (data) to arrive at a reasoned conclusion as to the state of health of the power supply that is modeled. Results may be presented in any number of forms to include, for example, a percentage such as seventy-five percent healthy or a remaining useful life (RUL) estimation such as 150 hours. The reasoners may estimate an RUL value, which can be used in condition-based maintenance (CBM) protocols for timely service to prevent untimely failures in an operational environment, and at the same time, without requiring unnecessary or too early replacement or repair of parts that are damaged, but are still useable.

RUL estimation is frequently performed in manufacturing and is used to evaluate, for example, the effectiveness of a particular process, material and package in a lifetime test. By comparing test lifetimes, predictions and conclusions can be made regarding one versus the other. The tests are either accelerated or highly accelerated: The intent is to reduce test time while maintaining test result validity. The reasoners and models are typically based on any number of mathematical expressions suitable for the test and the physics of failure. For example, there are any number of expressions that are typically used to model the reliability of devices subject to accumulated fatigue damage and the reasoners are commonly known as “model-based reasoners” or the more specific “reliability model-based reasoners” or “statistical model-based reasoners.”

The problem with physics-of-failure-based modeling, reliability-based reasoning, or statistical-based reasoning, as they have been used in the past, is that similar power systems are treated as having identical degradation paths. For example, two power systems, having similar electrical characteristics and similar construction are treated as if they will degrade identically. However, if the two power systems are exposed to different environments and/or subjected to different applications/activity, they will degrade differently. Further, reliability statistics cannot be used to accurately determine the likelihood of failure and the time-to-failure of a specific part that has been subjected to prior damage and which is operating in conditions that might or might not be causing additional accumulated damage.

Thus, a need exists in the industry to address the aforementioned deficiencies and inadequacies.

### SUMMARY OF THE DISCLOSURE

Embodiments of the present disclosure provide a prognostics-enabled power system and a method of using. Briefly described, in architecture, one embodiment of the system, among others, can be implemented as follows. The prognostics-enabled power system includes a power source and removably connected load. A sensor is connected to the power source and situated to identify at least one characteristic produced in response to the removably connected load on the power source. A programmable system is in communication with the sensor, the programmable system situated to calculate a value from the at least one characteristic, wherein the calculated value is indicative of a health status of the power source.

Briefly described, in architecture, a second embodiment of the system for sensing at least one of a state of health or a remaining useful life of a power source, among others, can be implemented as follows. The system includes a power source connected to a load. A switch is located between the power source and the load, wherein the switch is situated to control the connection between the power source and the load. A sensor is connected to the power source and situated to identify at least one characteristic produced in response to connection between the power source and the load. A programmable system is in communication with the sensor and situated to calculate a value from the at least one characteristic. Also included is a database having at least one of a quantity of predetermined data corresponding to at least one of identification data and calibration data of the power source and a quantity of user-configurable data corresponding to at least one of identification data and calibration data of the power source. The calculated value is correlated with at least one of the quantity of predetermined data and the quantity of user-configurable data to create an assessment about at least one of a state of health or a remaining useful life of the power source.

The present disclosure can also be viewed as providing methods for determining the health status of a power source. In this regard, one embodiment of such a method, among others, can be broadly summarized by the following steps: controlling a connection between a power source and a load; identifying at least one characteristic produced in response to the connection between the power source and the load; and calculating a value from the at least one characteristic, wherein the calculated value is indicative of a health status of the power source.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a graph illustrating a waveform created in response to an applied impulse load, in accordance with a first embodiment of the present disclosure.

FIG. 2 is a schematic diagram of a prognostics-enabled power system, in accordance with a second embodiment of the present disclosure.

FIG. 3 is a schematic diagram of a system for sensing at least one of a state of health or a remaining useful life of a power source, in accordance with a third exemplary embodiment of the present disclosure.

FIG. 4 is a flowchart illustrating a method determining the health status of a power source, in accordance with the second exemplary embodiment of the disclosure.

### DETAILED DESCRIPTION OF THE DISCLOSURE

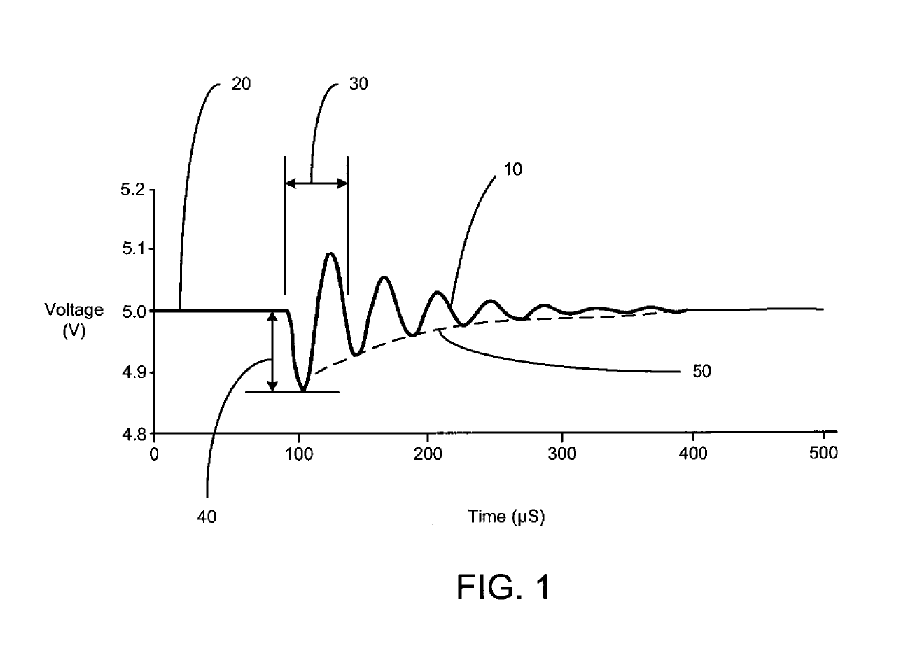

Embodiments of the present disclosure provide a programmable power system sensor and method, which may be used for determining a health status of a power source. FIG. 1 is a graph illustrating a waveform 10 created in response to an applied impulse load, in accordance with a first embodiment of the present disclosure. The graph illustrates a waveform 10 by mapping the voltage (V) over time (T), which is given in microseconds (μS). Initially, the voltage is at 5V and remains substantially constant between T=0 μS and T=100 μS. This initial voltage 20 is representative of a power supply having no impulse load change applied. At T=100 μS, an impulse load is applied to the initial voltage 20 to create the waveform 10, which is produced in response to the impulse load applied. As will be discussed herein, the waveform 10 may also be created by other methods, such as using a switch and controlling activation of a power source.

The waveform 10 has a period (T), designated by arrow 30, and an amplitude (A), designated by arrow 40, which may change over time. In FIG. 1, the waveform 10 is illustrated decreasing over time, such that the eventual frequency of the waveform 10 is 0. In other words, after a given period of time, the waveform 10 will flatten out when the voltage reaches a constant level. This may happen at or beyond 500 μS, such as is illustrated in FIG. 1, or at any other time. The shape of the waveform 10, including the wave period 30, amplitude 40, RC time constant 50, and any other wave characteristics, may reflect the damping factor of a feedback control loop used to regulate an output parameter, such as output voltage control provided by a switch-mode power supply (SMPS) or position control provided by the servo drive of an electromechanical actuator (EMA). Any of the period 30, amplitude 40, time constant 50 or any other characteristic, may be indicative of a health state of the power source, and expressed in a variety of terms, such as with a variable, an equation or a numerical value.

The waveform 10 may include a mathematical basis for determining the time constant 50, which may include one or more state vectors. A state vector is a collection of meaningful values that may represent direct and indirect measurements. For example, state vectors for some indirect measurements may include an efficiency of the power source, a ripple voltage, a frequency and a voltage regulation. Other indirect and direct measurements may also be used, as determined by design. The mathematical basis for determining the time constant 50, and subsequently the variable, equation or numerical value that is indicative of the health status of the power source, may begin with defining [symbol] as a state vector, which may represent an equivalent series resistant (ESR), a current transfer ratio (CTR) of an optically coupled feedback amplifier, and the ON resistance of a metal-oxide-semiconductor field-effect transistor (MOSFET) switch (R_{DS}_{_{—}}_{ON}) [symbol] may be a measurement vector representing measurements such as output voltage ripple (V_{RIPPLE}), filter cutoff frequency, (f_{c}) and output voltage step (ΔVₒᵤₜ); [symbol] may be a state vector, representing load, [symbol] may be the first derivative of the state vector, C and D are matrices, and [symbol] and [symbol] represent noise distributions.

Accordingly, state vector models within this mathematical basis can now be expressed as follows:

[symbol]

Temperature}

$$C = ( \begin{matrix}{c}_{11} & K & {c}_{1 n} \\ M & O & M \\ {c}_{m 1} & L & {c}_{mn}\end{matrix} ) m = 4 , n = 3$$

$$D = ( \begin{matrix}{d}_{11} & K & {d}_{1 n} \\ M & O & M \\ {d}_{m 1} & L & {d}_{mn}\end{matrix} ) m = 4 , n = 2$$

At this stage, the noise may be ignored in the real system for the state vector of models and first derivative of the state vector. If we plug into the state vector model for matrices C and D, each state can be expressed as follows:

V_{RIPPLE}=C₁₁ESR+C₁₂CTR+C₁₃R_{DS}_{_{—}}_{ON}+D₁₁I_{LOAD}+D₁₂T (³)

f_{c}=C₂₁ESR+C₂₂CTR+C₂₃R_{DS}_{_{—}}_{ON}+D₂₁I_{LOAD}+D₂₂T (4)

η=C₃₁ESR+C₃₂CTR+C₃₃R_{DS}_{_{—ON}}+D₃₁ I_{LOAD}+D₃₂T (⁵)

ΔV_{OUT}=C₄₁ESR+C₄₂CTR+C₄₃R_{DS}_{_{—}}_{ON}+D₄₁I_{LOAD}+D₄₂T (6)

Within this mathematical basis, each model may have measurable features. For example, ESR may be correlated with load current and ripple voltage. CTR may be correlated with several features, including output voltage, output current, and frequency response. R_{DS} may be correlated with efficiency and load current. Based on these correlations, and ignoring the features that have little association with each model, the simplified state equations are the following:

η=C₃R_{DS}_{_{—}}_{ON}+D₃I_{LOAD} (7)

V_{RIPPLE}C₁ESR+D₁I_{LOAD} (8)

V_{RIPPLE}=C₁ESR+D₁I_{LOAD} (9)

ΔV_{OUT}C₂CTR+C₃R_{DS}_{_{—}}_{ON}+D₁I_{LOAD} (10)

To illustrate by example, the following uses a degradation model for R_{DS} to show how the state vector equations model a progression of the health status of a power source. Since the function, f, from equation (2) is non-zero, the integral yields the following:

R_{DS}_{_{—}}_{ON}(t)=R_{DS}_{_{—}}_{ON}(t₀)e^{γ}^{_{R}}^{t-t}^{₀}⁾ (11)

In this equation, R_{DS} (t0) may be a base value for our time projection. It is obtained from the state description equation (1) as follows:

$${R}_{DS \_ ON} = \frac{η - {D}_{3} {I}_{LOAD}}{{C}_{3}} \qquad ( 12 )$$

Now by defining a failure threshold for R_{DS} based on system requirements, equation (11) can be used to get the health status, such as a time-to-failure. This result is given by:

$$Time\_To \_Failure ( t - {t}_{o} ) = \frac{1}{{γ}_{R}} Ln [ \frac{{R}_{DS \_ {ON}^{( FAIL ) = 400 m Ω}}}{\frac{η - {D}_{3} {I}_{LOAD}}{{C}_{3}}} ] \qquad ( 13 )$$

Similarly, we can obtain ESR and CTR.

$$\begin{matrix}Time\_To \_Failure ( t - {t}_{o} ) = \frac{1}{{γ}_{R}} Ln [ \frac{{ESR}_{( FAIL ) = 100 m Ω}}{\frac{{V}_{RIPPLE} - {D}_{1} {I}_{LOAD}}{{C}_{1}}} ] & ( 14 ) \\ Time\_To \_Failure ( t - {t}_{o} ) = \frac{1}{{γ}_{R}} Ln [ \frac{{CTR}_{( FAIL ) = 0.7}}{\frac{{f}_{c} - {D}_{2} {I}_{LOAD}}{{C}_{2}}} ] & ( 15 )\end{matrix}$$

Thus, as can be seen, state vectors may be used with the programmable power system sensor, and in operation of the system 10 in determining a health status of a power source.

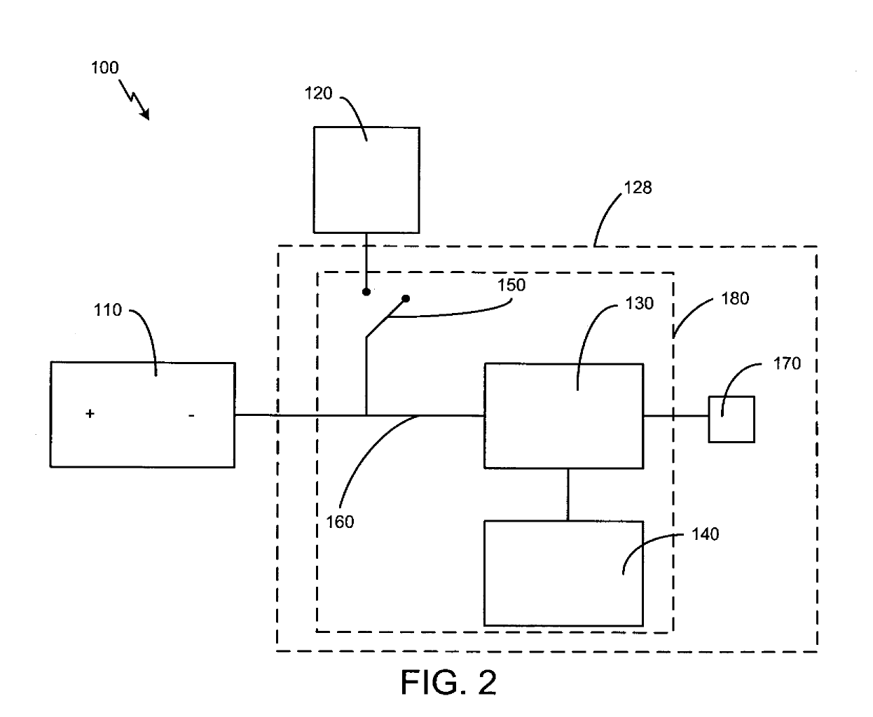

FIG. 2 is a schematic diagram of a prognostics-enabled power system 100, in accordance with a second embodiment of the present disclosure. The prognostics-enabled power system 100 includes a power source 110 and a removably connected load 120. A sensor 128 connected to the power source 110 and situated to identify at least one characteristic produced in response to the removably connected load 120 on the power source 110. This may include controlling acquisition of a characteristic, such as a waveform created in response to the removably connected load 120 on the power source 110. The sensor 128 includes a programmable system 140 in communication with a data acquisition system (DAQ) 130. The programmable system 140 may calculate a value from the at least one characteristic. The calculated value may be indicative of a health status of the power source 110, such as by indicating a state-of-health (SOH) or a remaining useful life (RUL) of the power source 110. The sensor 128 may also include a switch 150, a connection 160 and a communication element 170. The DAQ system 130, programmable system 140, switch 150 and connection 160 may be considered a transducer 180.

The prognostics-enabled power system 100 may have applications in a variety of industries, including for example the aeronautics industry, the defense industry, and the automotive industry. As is known to one having ordinary skill in the art, virtually all industries require the use of power supply in one way or another, and the prognostics- enabled power system 100 may be used in any of them. Commonly, the power supply is an integral component of other machinery or devices that are used in the industry. For example, virtually any spacecraft in the aeronautics industry has a complex power system that is critical to the proper function of the spacecraft. Knowing that the power system will perform as engineered at all times allows for successful completion of a mission while at the same time preventing unneeded and wasteful maintenance or replacement of parts for fear of system failure. The prognostics-enabled power system 100 may be used to provide engineers, designers, or first-hand users of the power systems with the knowledge and security that the power system is functioning with a particular health status. This allows the engineer, designer or first-hand user to determine whether the power system needs repair, replacement or is working in good working order.

Within any industry, the prognostics-enabled power system 100 may include a power source 110 that has a source of energy or power supply. Commonly, this will be a power source 110 that is associated with an electrical or mechanical device. However, the power source 110 may also be associated with other devices using a measurable source of energy, including chemical, or biological devices, or any other device, or a combination thereof. The power source 110 may also be located within, integral with, or connected to a device or combination of devices that require the use of electricity. For example, this may include power sources 110 including but not limited to SMPS and EMA servo drives. The use of electricity may be characterized as the consumable power, which is represented as the load 120 in FIG. 2. The load 120 may include any type of power consumption, such as power consumed to run a device, power consumed to transmit information, power consumed during a conversion of energy, or even power consumed within a sensor 128 that is self-powered with a batter cell or other self-powering power supply.

The load 120 may have a removable connection with the power source 110, whereby the load 120 may be fully connected, partially connected, or has no connection to the power source 110. Commonly, the load 120 will have a removable connection with the power source 110 such that the voltage from the power source 110 will fluctuate, such as is illustrated in FIG. 1. However, the load 120 is not required to create a fluctuating voltage, as the sensor 128 will be successful with any voltage output from the power source 110. One way to create a voltage fluctuation, which may also be referred to as forcing a load change or creating a voltage disturbance, is through the use of a switch 150 located between the power source 110 and the load 120. The switch 150 may control the removable connection between the power source 110 and the load 120. A variety of switches 150 may be used, such as a relay, a MOSFET device or any other electronic switch. In addition, the sensor 128 may provide output signals to control the fluctuation, such as static loads, impulse loads, active loads and reactive loads. For example, the static load may be sized to draw a certain percentage of a target power of the power source 110. The impulse load may be equivalently sized and create a momentary abrupt load change to elicit a response based on a damped sinusoidal waveform, as depicted in FIG. 1. The sensor 128 may automatically control switching of the static load and the impulse load.

The sensor 128 may also function with a connection that is not disrupted between the power source 110 and the load 120. A connection that is not artificially of forcefully disrupted may facilitate a substantially constant voltage level, but natural or inherent voltage fluctuations are available-through typical application events, such as power up or dynamic loading. When there is no fluctuation in the voltage, due to the lack of a disturbance or impulse, the sensor 128 may still detect anomalous characteristics in the output voltage of the power source 110, even when there is no significant visible change. This may allow the sensor 128 to determine a health status of a power source 110 without impulse testing or creating a fluctuation in the voltage. This may lead to devices that are more robust and with device components where stability and load maintenance are critical to proper operation of the device. Accordingly, environmental variables may be utilized to determine a health status or make a prediction about the RUL of a device. Furthermore, the sensor 128 may be able to not only detect anomalous characteristics, but also catalog and store the data for future use. This may also include storing such information as a date/time stamp, a voltage read-out and health status information, which may be available for downloading from the prognostics-enabled power system 100 for analysis. Over time, a dictionary of the variations that occur may be compiled.

The sensor 128 may include any device or instrumentation that is capable of identifying at least one characteristic produced in response to the removably connected load 120 on the power source 110. For example, the sensor 128 may be considered a “Smart Sensor” which may be characterized as a sensor which, in addition to the actual measurement capture, the complete signal conditioning and signal processing may be together in one package. The sensor 128 may include a variety of connections 160 to connect one or more components of the sensor 128, or connect the sensor 128 with another element. The sensor 128 is connected to the power source 110 as a black box, or in other words, so the sensor 128 is only viewed in terms of input, output and transfer characteristic without knowledge of the inner workings. This may be accomplished by connecting the sensor 128 with a connection 160 that includes a voltage measurement mode with physical connection to +/− output terminals of the power source 110, or with a current pickup loop. A number of other connections are also available to be used with the sensor 128, all of which are considered within the scope of the present disclosure.

The DAQ system 130 of the sensor 128 may be used to identify at least one characteristic produced in response to the removably connected load 120 on the power source 110. As discussed with respect to the connection between the load 120 and the power source 110, a variety of voltage fluctuations may be created through the removable connection. This may include purposefully generated voltage disturbances, voltage fluctuations that are generated as a result of ordinary use of the power source 110, or any other voltage disturbance. These voltage fluctuations may be completed in a variety of ways, such as through a predetermined schedule of voltage disruptions, automated disruptions, or disruptions that take place upon a start process or end process of the power source 110.

Commonly, a voltage fluctuation creating a characteristic frequency (i.e., waveform) of the voltage will be the response to the removably connected load 120 on the power source 110. In this case, the DAQ system 130 may identify the characteristic frequency corresponding to the waveform created as the characteristic produced in response to the removably connected load 120. As discussed with respect to FIG. 1, this characteristic may be expressed in terms of a numerical value, a variable or an equation. However, a voltage fluctuation may be only one of many responses to the removably connected load 120 with the power source 110. Other responses may include a varying voltage level, a constant voltage level or no change in the voltage level. Accordingly, DAQ system 130 may identify any characteristic produced in response to the removably connected load 120 on the power source 110.

To best determine the health status of the power source 110, sensor 128 includes a programmable system 140 in communication with the DAQ system 130. The programmable system 140 may be in direct or indirect communication with the DAQ system 130 or it may be integral with the sensor 128. Commonly, the programmable system 140 will be an integral component of the sensor 128, however any design configuration is permissible. For example, the programmable system 140 may be external to and in communication with the sensor 128. The programmable system 140 may calculate a value from the characteristic identified by the sensor DAQ system 130. This may include a value in any format, including numerical, variable or with an equation. For example, the calculated value may be expressed in terms of eigenvalues, where the calculated value is an intrinsic eigenvalue or a plurality of intrinsic eigenvalues. The calculated value may also be a calculated variation between eigenvalues from a nominal, or predetermined value corresponding to a particular health status of the power source 110.

The calculated value may be indicative of a health status of the power source 110. The health status may be generally characterized as any determination of functionality of a device, which may include a determination of functionality of a device in relation to the device's useful life. Accordingly, the health status may include a variety of health status information, such as a SOH or a RUL of the power source 110. The health status of the power source 110 may include any other form of prognostic data that is indicative of a health status of the power source 110. The SOH of the power source 110 may be characterized as any information corresponding to a past, current or future determination of functionality of the power source 110. This may be given in a variety of formats, including computerized data, a numerical value, a graphical value or through written information. The RUL of the power source 110 may be characterized as a prediction of a time at which a component will no longer perform a particular function. Similar to the SOH, the RUL may also be given in a variety of formats, such as a given time or a predictive date.

The programmable system 140 may also calculate a value based on an analysis or reference to additional data. For example, the programmable system 140 may contain internal data to be used with calculating the value from the characteristic. Additionally, the programmable system 140 may correlate the calculated value with a quantity of predetermined component degradation data, such as may be stored remotely in a centralized prognostic health management (PHM) database.

The sensor 128 may also include other components, such as a communication element 170 in communication with the transducer 180. The communication element 170 may communicate data and information from the prognostics-enabled power system 100 to an external entity, such as mission control or a maintenance depot. Although any information may be communicated through the communication element 170, the characteristic, the calculated value or the health status of the power source may be commonly communicated from the prognostics-enabled power system 100. For example, the programmable system 140 may implement digital signal processing algorithms to analyze a power source 110 response and calculate the transducer 180 output based on a user-selected component/measurement mode.

The transducer 180, having the DAQ system 130, programmable system 140, switch 150 and connection 160 may be subject to various configurations. For example, the transducer 180 may be configured for IEEE 1451.4 operation, wherein the communication element 170 may include a “one-wire” bi-directional digital port for a transfer electronic data sheet (TEDS) along with a voltage output of the transducer 180 (e.g. 0-10V where 10V=100% health and 0V=0% health). If the sensor 128, on the other hand, is configured for IEEE 1451.1 operation, the communication element 170 may include an Ethernet port and support networking protocols such as TCP/IP. IEEE 1451 compatibility provides a standardized communication interface for the prognostics-enabled power system 100, which may simplify the connectivity and maintenance of the sensor 128. This may also allow “plug-and-play” with other IEEE 1451-compatible systems, among different devices, using multiple network controls. With either an IEEE 1451.4 or IEEE 1451.1 configuration, the notion of IEEE 1451 plug-and-play is made possible through TEDS. Other communication elements 170 are also available, such as RS-232/485, CAN, CC-Link, DeviceNet, BACNet and wireless communication, which could easily be supported natively or through external communication bridge adapters.

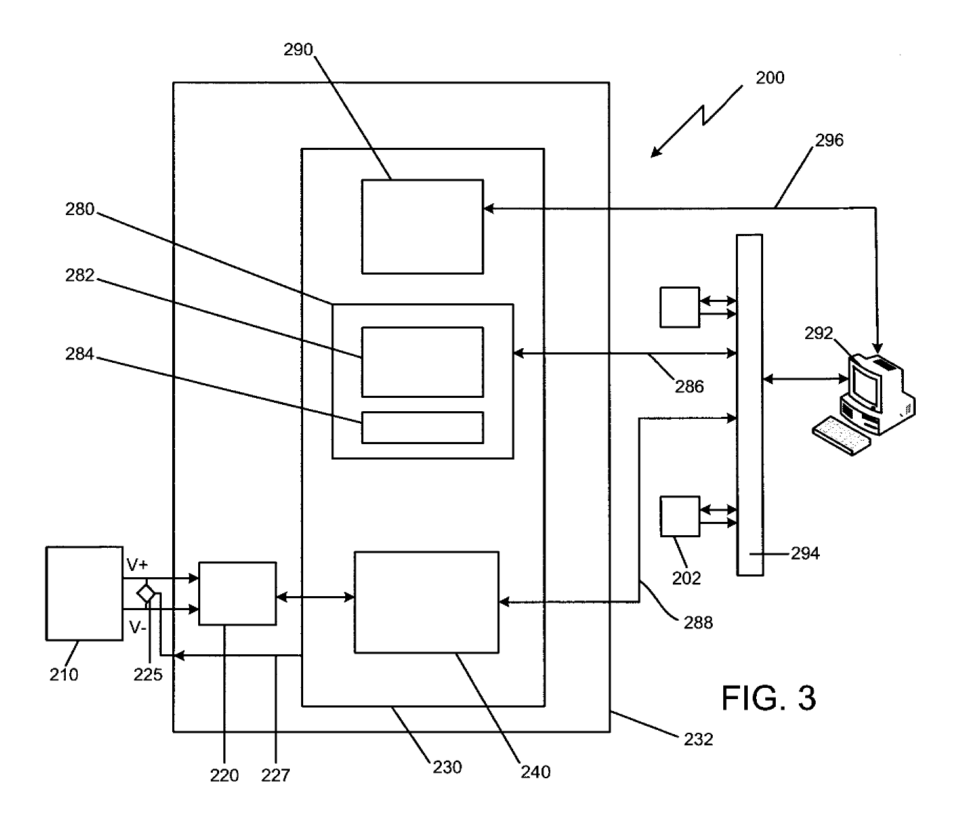

FIG. 3 is a schematic diagram of a system 200 for sensing at least one of a state of health or a remaining useful life of a power source, in accordance with a third exemplary embodiment of the present disclosure. The system 200 includes a power source 210 connected to a switchable load 225. The sensor 232 provides digital output signals 227 to control load switching and analog input circuitry 220 to acquire the response of the power source 210. A sensor 232 is connected to the power source 210 and may identify at least one characteristic produced in respond to the connection between the power source 210 and the switchable load 225. A programmable system 240 in communication with the sensor 232 may calculate a value from the at least one characteristic.

A local database 280 is also included in the sensor 232, in communication with any number of other components. The local database 280 may have at least one of a quantity of predetermined data 282 corresponding to at least one of identification data and calibration data of the sensor 232 and a quantity of user-configurable 284 data corresponding to at least one of programmable measurement mode and calculation confidence of the sensor 232. The calculated value may be correlated with at least one of the quantity of predetermined data 282 and the quantity of user-configurable data 284 to create an assessment about at least one of a state of health or a remaining useful life of the power source 210. The programmable system 240, the local database 280 having the predetermined data 282 and the user-configurable data 284 may be located within a microprocessor core 230.

The system 200 of the third exemplary embodiment is similar to the prognostics-enabled power system 100 of the second exemplary embodiment and may contain similar or identical features and components. Accordingly, the disclosure of the second exemplary embodiment is considered within the scope of the system 200 of the third embodiment. The system 200 includes a switchable load 225 located between the power source 210 and the sensor 232. The sensor 232 provides digital output signals 227 to control the connection between the power source 210 and the switchable load 225. The switchable load 225 may include electrically operated switches, or other programmable switches, but may also include non-electrically operated switches. Accordingly, the switchable load 225 may include any device that may control the connection between the power source 210 and its load. The switchable load 225 may control the voltage output from the power source 210 whereby a voltage fluctuation may be produced and the corresponding response waveform acquired by the analog input circuitry 220 of the sensor 232, as discussed in greater detail with regards to FIG. 2.

The sensor 232 having the local database 280 may have various quantities and types of data. The local database 280 may include any type of data storage device, but will commonly be employed as a local database 280 that includes a TEDS. TEDS may be defined in accordance with the IEEE 1451 interface standards, which may include a standardized method of storing transducer identification, calibration, correction data, and manufacturer-related information. Commonly, the information contained in TEDS will include information needed by a measurement instrument or a control system to interface it with the transducer.

The local database 280 may have information in at least different forms: predetermined data 282 and user-configurable data 284. Both the predetermined data 282 and user-configurable data 284 may correspond to at least one of identification data and calibration data of the sensor 232, but may also correspond to other types of data, such as correction data and manufacturer-related information. Commonly, the quantity of predetermined data 282 within the local database 280 may include information such as a manufacturer ID, a model number, version information and a serial number, to name just a few. The quantity of user-configurable data 284 may be selected by a user of the system 200 and changed as desired. This may include programmable measurement mode data relating to measuring the SOH or RUL of a specific power supply system component, including but not limited to feedback amplifier, output filter capacitor, pulse width modulation (PWM) controller, MOSFET switch, gate driver and bootstrap capacitor. Other types of data may be included in the local database 280, the predetermined data 282 and user-configurable data 284, all of which are considered within the scope of the present disclosure.

Another aspect of the present disclose is the ability to program the sensor 232 to report an assessment of its own health status, in addition to a health status of a power source, or any other component that is being monitored. In other words, the sensor 232 may be programmed to report its own SOH or RUL, which may be important in redundant sensing schemes like those employed with critical avionic control systems. This may be done along or in addition to determining a health status of a power source 210, or any other component. The sensor 232 may also be able to produce a confidence interval associated with each determination of a health status, or each health calculation made. The confidence interval may be stored in the local database 280 with the user-configurable data 284 and communicated with any data corresponding to the health status. For example, with an IEEE 1451.1 configuration, the confidence interval may be stored in a TEDS user data segment and included in an IEEE 1451.1 data packet along with a health calculation.

The system 200 illustrated in FIG. 3 may include other components, such as a server 290 in communication with the programmable system 240, the local database 280, and/or an external client 292. The server 290, which may be located in the microprocessor core 230, may be an embedded IEEE 1451.1 NCAP server, or another network-compatible server. If the server includes an IEEE 1451.1 NCAP server, it may be directly connected to the client 292 through a communication connection 296, such as an Ethernet connection. In one of many alternatives, the sensor 232 may also be connected to the client 292 through an IEEE 1451.4 data acquisition system (DAC)) 294. Accordingly, the sensor 232 may provide a digital input/output signal 286 to enable communication between the IEEE 1451.4 DAQ 294 and the local database 280 as well as an analog output signal 288 to report the transducer output calculated by the programmable system 240. Other IEEE 1451.4 plug-and-play sensors 202 may also be connected to the same DAQ 294 that the system 200 is connected to.

In accordance with either of the first, second or third exemplary embodiments of the present disclosure, various alterations and accuracy-enhancing steps may be taken to provide accurate health status data. For example, the programmable power system sensor may include algorithms that are executed by the programmable system, to enhance the efficiency or accuracy of the system. These algorithms may be updated over time and refined to provide better health status data as the system is used. In addition, the system may include the use of signal conditioning or adaptive load capabilities to attenuate the voltage from the power source. This may allow the voltage to be scaled, either up or down, to provide a voltage level that is compatible with the system, or produces the best results in the system. To accomplish this, a simple voltage divider circuit using precision resistors may scale the voltage from the power source. This may be considered a calibration constant and may be defined in the database or the TEDS. Signal conditioning may be necessitated by the sensor or control circuitry within the sensor.

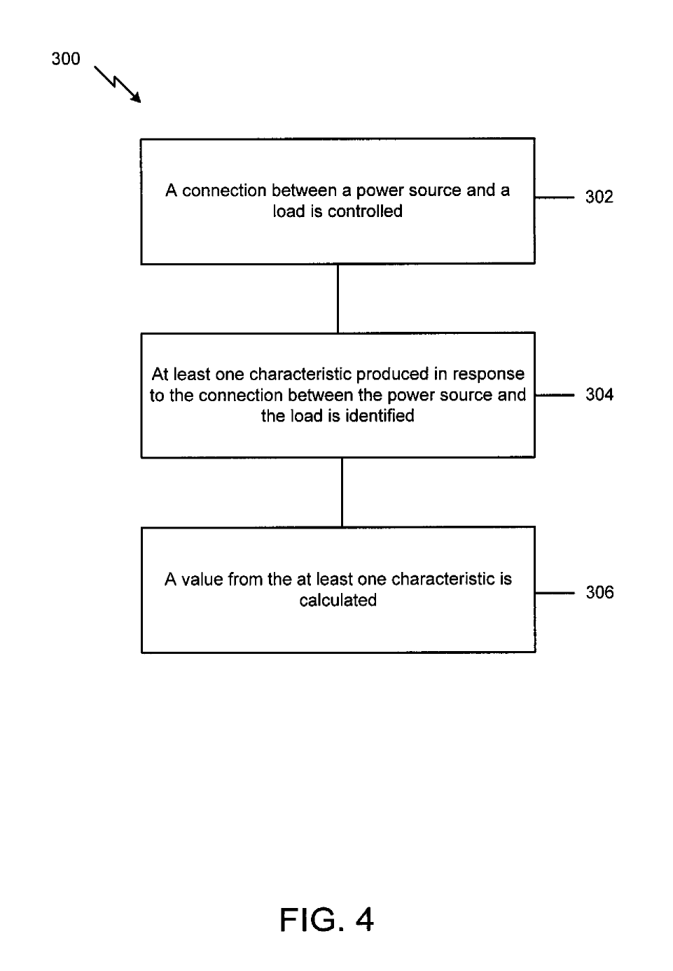

FIG. 4 is a flowchart 300 illustrating a method determining the health status of a power source, in accordance with the second exemplary embodiment of the disclosure. It should be noted that any process descriptions or blocks in flow charts should be understood as representing modules, segments, portions of code, or steps that include one or more instructions for implementing specific logical functions in the process, and alternate implementations are included within the scope of the present disclosure in which functions may be executed out of order from that shown or discussed, including substantially concurrently or in reverse order, depending on the functionality involved, as would be understood by those reasonably skilled in the art of the present disclosure.

As is shown by block 302, a connection between a power source and a load is controlled. At least one characteristic produced in response to the connection between the power source and the load is identified. (Block 304). A value from the at least one characteristic is calculated. (Block 306). The calculated value may be indicative of a health status of the power source. The method of determining the health status of a power source may also include the steps of correlating the calculated value with at least one of a quantity of predetermined data and a quantity of user-configurable data. Once correlated, an assessment about the health status of the power source may be created from the correlated and calculated value. The value may be programmatically reconfigured to adjust for variables and to provide an accurate health status determination. In accordance with the second exemplary embodiment, and the disclosure with reference to FIG. 2, at least one characteristic may be identified with an IEEE 1451-compatible sensor.

It should be emphasized that the above-described embodiments of the present disclosure, particularly, any “preferred” embodiments, are merely possible examples of implementations, merely set forth for a clear understanding of the principles of the disclosure. Many variations and modifications may be made to the above-described embodiments) of the disclosure without departing substantially from the spirit and principles of the disclosure. All such modifications and variations are intended to be included herein within the scope of this disclosure and the present disclosure and protected by the following claims.

1. A prognostics-enabled power system comprising:
a power source and removably connected load;
a sensor connected to the power source and situated to identify at least one characteristic produced in response to the removably connected load on the power source; and
a programmable system in communication with the sensor, the programmable system situated to calculate a value from the at least one characteristic, wherein the calculated value is indicative of a health status of the power source.

2. The prognostics-enabled power system of claim 1, further comprising a switch located between the power source and the load, wherein the switch controls the removable connection between the power source and the load.

3. The prognostics-enabled power system of claim 1, wherein the sensor is connected to the power source with at least one of a direct connection to output voltage terminals or a non-invasive current pickup loop.

4. The prognostics-enabled power system of claim 1, wherein the calculated value is an intrinsic eigenvalue.

5. The prognostics-enabled power system of claim 4, wherein the programmable system is situated to correlate the calculated value with a quantity of predetermined component degradation data.

6. The prognostics-enabled power system of claim 1, wherein the health status of the power source includes at least one of a state of health and a remaining useful life of the power source.

7. The prognostics-enabled power system of claim 1, further comprising a communication element in communication with the sensor, the communication element situated to communicate at least one of the characteristic, the calculated value and a health status of the power source.

8. The prognostics-enabled power system of claim 1, wherein the programmable system may be reconfigured programmatically by a user.

9. The prognostic-enabled power system of claim 1, wherein the programmable system further comprises a programmable measurement mode wherein the programmable system calculates a value from the at least one characteristic indicative of a health status of the sensor itself.

10. The prognostic-enabled power system of claim 1, wherein the programmable system calculates a confidence interval associated with the calculated value indicative of the health status of the power source.

11. A system for sensing at least one of a state of health or a remaining useful life of a power source, the system comprising:
a power source connected to a load;
a switch located between the power source and the load, the switch situated to control the connection between the power source and the load;
a sensor connected to the power source and situated to identify at least one characteristic produced in response to connection between the power source and the load;
a programmable system in communication with the sensor, the programmable system situated to calculate a value from the at least one characteristic;
a database having at least one of a quantity of predetermined data corresponding to at least one of identification data and calibration data of the power source and a quantity of user-configurable data corresponding to at least one of identification data and calibration data of the power source, wherein the calculated value is correlated with at least one of the quantity of predetermined data and the quantity of user-configurable data to create an assessment about at least one of a state of health or a remaining useful life of the power source.

12. The system of claim 11, wherein the power source is integral with the sensor.

13. The system of claim 11, wherein the programmable system is reconfigured programmatically by a user.

14. The system of claim 13, wherein the programmable system is reconfigured programmatically with a user-configurable transducer mode, wherein the user-configurable transducer mode includes at least one of a power supply, feedback amplifier, filter cap, half-bridge, MOSFET switch, gate driver and bootstrap cap.

15. The system of claim 11, further comprising a server in communication with at least one of the sensor, the programmable system and the database, and an external processor.

16. The system of claim 15, wherein the server is an embedded IEEE 1451.1 NCAP server.

17. The system of claim 11, further comprising a data acquisition system, in communication with at least one of the sensor, the programmable system and the database.

18. The system of claim 11, wherein the sensor is situated to measure at least one waveform associated with the identity of the at least one characteristic in response to the connection of the power source and the load.

19. The prognostic-enabled power system of claim 11, wherein the programmable system further comprises a programmable measurement mode wherein the programmable system calculates a value from the at least one characteristic to create an assessment about at least one of a state of health or a remaining useful life of the sensor itself.

20. The prognostic-enabled power system of claim 11, wherein the programmable system calculates a confidence interval associated the assessment about at least one of a state of health or a remaining useful life of the power source.

21. A method of determining the health status of a power source, the method comprising:
controlling a connection between a power source and a load;
identifying at least one characteristic produced in response to the connection between the power source and the load; and
calculating a value from the at least one characteristic, wherein the calculated value is indicative of a health status of the power source.

22. The method of claim 21, further comprising the steps of:
correlating the calculated value with at least one of a quantity of predetermined data and a quantity of user-configurable data; and
creating an assessment about the health status of the power source from the correlated and calculated value.

23. The method of claim 21, wherein the step of identifying at least one characteristic further comprises identifying the at least one characteristic with an IEEE 1451-compatible sensor.

24. The method of claim 21, further comprising the step of programmatically reconfiguring the calculated value.
